(19) United States
(12) Patent Application Publication
(10) Pub. No.: US 2014/0208427 A1
(43) Pub. Date: Jul. 24, 2014

(54) APPARATUS AND METHODS FOR DETECTING DATA ACCESS

(71) Applicant: Jonathan Grier, Lakewood, NJ (US)

(72) Inventor: Jonathan Grier, Lakewood, NJ (US)

(21) Appl. No.: 14/226,797

(22) Filed: Mar. 26, 2014

Related U.S. Application Data
(63) Continuation-in-part of application No. 13/073,978, filed on Mar. 28, 2011.
(60) Provisional application No. 61/805,571, filed on Mar. 27, 2013.

(51) Int. Cl. H04L 29/06

(52) U.S. Cl. CPC H04L 63/1408
USPC 726/23

(57) ABSTRACT

The following abstract is not intended as a limiting description of the invention. Apparatus and methods are provided for detecting in real-time, data access in an information or file system and generating an alert to indicate a type of access. File activity is monitored on a network device over discrete, uninterrupted time periods. A determination is made whether a minimum number of files within a group of files were accessed during at least one of the time periods. If enough files were accessed during the time period a determination is made whether they were all accessed by a single action. The pattern of the file access is analyzed and compared to known patterns of access and an alert may be generated to indicate the results of the comparison.

### CROSS REFERENCE TO RELATED APPLICATIONS

This application claims the benefit of the filing date of U.S. provisional patent application No. 61/805,571 entitled “Method to Determine Nature of Bulk Access” which was filed on Mar. 27, 2013 and U.S. patent application Ser. No. 13/073,978 entitled “Method and System for Forensic Investigation of Data Access”, which was filed on Mar. 28, 2011. Both of these applications share the same inventor as this application and are hereby incorporated by reference as if set forth in their entirety herein.

### FIELD OF THE INVENTION

The invention relates generally to data copying and more particularly to apparatus and methods for detecting potentially hazardous data access.

### BACKGROUND OF THE INVENTION

Data exfiltration is the unauthorized copying, transfer or retrieval of data from a computer or server. A recent, highly publicized, example of data exfiltration can be found in the 2014 data breach at Target™ that compromised credit card numbers and other personal information for over 100 million customers. The copying was apparently going on for weeks before it was detected.

Existing technology to detect data exfiltration, such as DLP (data loss prevention), typically attempts to identify “sensitive” data and track it as it moves across systems and perimeters, or looks for signs of attack and intrusion. In other words, conventional technology works by identifying particular information as “sensitive,” and enforcing a corresponding policy regarding sensitive information. However, determining if particular data is “sensitive” is a difficult task: automated efforts are too weak, manual efforts too slow. More importantly, the concept of data being “sensitive” or not is misguided. It ignores context, intent, quality, and quantity. Often parts of even the most “sensitive” data will be shared with appropriate entities and trusted recipients. By contrast, even the most mundane data can be devastating if exposed indiscriminately in vast quantities.

Exfiltration may take many forms: one exfiltrator might encrypt files and send them over a network, another might hide the files steganographically in JPEGs, and an insider might simply burn a CD or copy files to a flash drive and carry it away. However, despite the different modes and methods, most exfiltration shares a common trait: a large number of files are rapidly read and then their content is copied, encoded and/or transmitted elsewhere (collectively and individually referred to herein as “copied,” “replicated,” duplicated” or some variation thereof). These patterns of rapid replication are common when attempting to exfiltrate a large quantity of data in a short period of time—especially when the exfiltrator is unfamiliar with the data.

In contrast to copying, routine access of data files is typically incremental in nature; files are opened as needed. Routine access is also typically selective; only certain files are opened while others are ignored. Additionally it is temporally irregular: files are accessed in response to user or system activity, followed by a lull in access until the next activity causes new file access.

In view of the foregoing it would be advantageous to provide improved apparatus and methods for detecting data access. It would be further advantageous to detect data access in real time or within a relatively short time after it occurs. It would also be advantageous, to provide such apparatus and methods that create an alert when data access is detected.

### BRIEF SUMMARY OF THE INVENTION

Many advantages will be determined and are attained by the invention, which in a broad sense provides apparatus and methods for detecting the opening or access of files by an entity within a certain period of time, analyzes the pattern of access (e.g. the number of times each file is accessed, the speed at which they are accessed, the sequence in which they are accessed, which files are accessed—e.g. are any skipped, etc.) and then stores the pattern, at least temporarily, for further analysis (either immediately or at some subsequent time).

In a broad sense one or more embodiments of the invention provide(s) apparatus and methods for determining data access in real time or at least within a relatively short period of time after such access occurs. Methods and apparatus are provided which detect the opening or access of a large number of files by an entity within a certain period of time, analyzes the pattern of access and then compares the pattern to known patterns of access to determine if the access is different from the known access patterns. In one or more implementations of the invention, when the pattern does not match the known patterns the apparatus and method may create an alert indicating that additional investigation may be required. In one or more implementations of the invention, when the pattern does match the known patterns the apparatus and method may create an alert indicating that additional investigation may be required.

Implementations of the invention may provide one or more of the features disclosed below.

One or more embodiments of the invention provide(s) a method for detection of data access in a computer. The method includes a processor monitoring access to a set of data that is stored within a folder. The processor detects access to an amount of the data that exceeds a threshold amount within a time period and detects a pattern of the access.

One or more embodiments of the invention provide(s) an apparatus for detecting data access in a filesystem that stores data in groups. The apparatus includes a sensor configured to monitor access to data stored in a group. The sensor is also configured to store multiple times associated with the access. The apparatus also includes an analyzer engine configured to determine, from the stored times, that the amount of accessed data includes an amount of data, from the group, that exceeds a threshold amount of data within a certain time period.

One or more embodiments of the invention provide(s) a method for detecting data access. The method includes creating a set of access patterns related to software programs. A processor monitors access to set of data and detects a pattern of access to the set of data. The processor compares the pattern of access to the set of data with the created set of access patterns and stores, at least temporarily, a result of the comparison between the pattern of access and the set of access patterns.

One or more embodiments of the invention provide(s) a method for detection of data access in a computer. The method includes a processor monitoring access to a set of data in real-time. The set of data is stored as a group of data. The processor detects various times of access to an amount of the data that exceeds a threshold amount of the set of data and each of the various times falls within a time period.

One or more embodiments of the invention provide(s) a method for detection of a macro event. The method includes a processor monitoring multiple micro events, such that some of the micro events may be grouped into at least one macro event. The processor detects the occurrence of an amount of the micro events grouped into the macro event that exceeds a threshold amount of occurrences of the micro events within a time period. The method further includes the processor detecting that the amount of occurrences of the micro events that exceeds the threshold was caused by a macro event.

The invention will next be described in connection with certain illustrated embodiments and practices. However, it will be clear to those skilled in the art that to various modifications, additions and subtractions can be made without departing from the spirit or scope of the claims.

### BRIEF DESCRIPTION OF THE DRAWINGS

For a better understanding of the invention, reference is made to the following description and examples, taken in conjunction with the accompanying drawings, in which like reference characters refer to like parts throughout, and in which:

FIG. 1 is a block diagram of a device for examining an information system or filesystem and determining a nature of an access performed thereon in accordance with one or more embodiments of the invention;

FIG. 2 is a block diagram of potential time periods for the device of FIG. 1;

FIG. 3 is a flowchart illustrating a possible first stage of a method for determining a nature of an access performed on an information system or filesystem in accordance with one or more embodiments of the invention;

FIG. 4 is a flowchart illustrating another possible stage of the method of FIG. 3;

FIG. 5 is a flowchart illustrating still another possible stage of the method of FIG. 3;

FIG. 6 is a flowchart illustrating yet another possible stage of the method of FIG. 3; and

FIG. 7 illustrates a possible database of known patterns of access employed by existing software programs.

The invention will next be described in connection with certain illustrated embodiments, examples and practices. However, it will be clear to those skilled in the art that various modifications, additions, and subtractions can be made without departing from the spirit or scope of the claims.

### DETAILED DESCRIPTION OF THE INVENTION

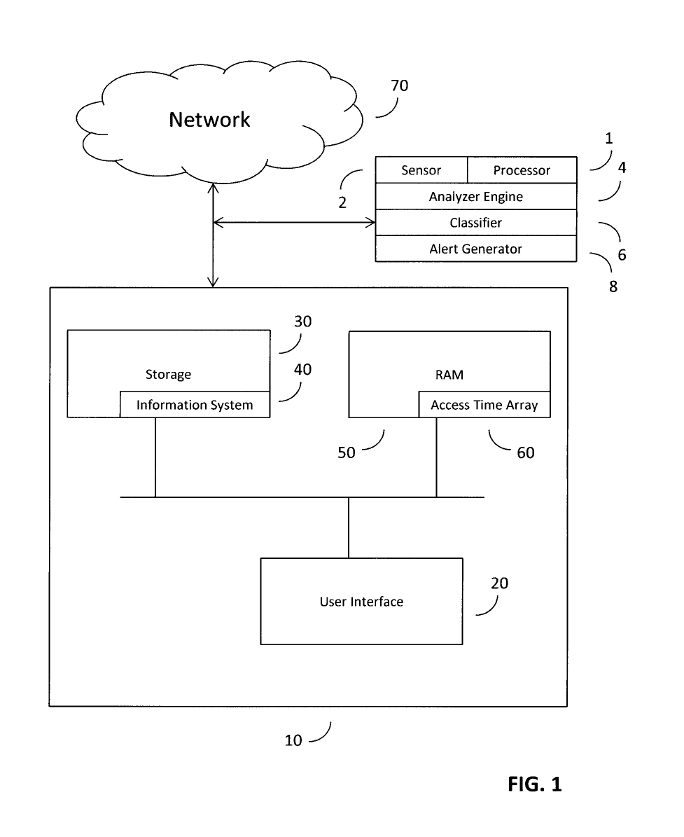

Referring to the drawings in detail wherein like reference numerals identify like elements throughout the various figures, there is illustrated in FIGS. 1-7 apparatus and methods for detecting in real-time or substantially real-time, data access in an information or file system and providing an alert. Those skilled in the art will recognize that the term substantially real-time is not a vague term in that there are typically small delays associated with electronics which typically prevent activities from occurring at exactly real-time. The term “substantially real-time” takes into account the possibility that delays will be entered into the system based on real world applications. Thus the phrase real-time and substantially real-time are used interchangeably herein and should be understood to mean as the action occurs or within a short amount of time (e.g. less than 10 minutes—this time period is a non-limiting example) thereafter. Additionally, the invention is not limited to real-time. It is equally applicable to analysis of historical activity. While the following description will be limited to a networked computer, those skilled in the art will recognize that the invention is not so limited. The following description is equally applicable to a stand-alone computer or device, one or more elements of a network or any other device or groups of devices that store(s) data. Thus the term computer may be deemed to refer to any one or more of these devices as appropriate unless the context clearly dictates otherwise. The inventor contemplates examining a hierarchical filesystem, such as Microsoft Windows NTFS or Linux ext3, which stores files within folders; however other types of filesystems or information systems may be examined as well. For example, the data may be any group or delineation (e.g. Windows 7 Libraries, tagging systems, etc.). The group can be implicit: e.g. all files with a certain extension. Additionally, the file can simply be associated with a group of files. For example, a tagging system associates files with tags, but does not store them within the tag. As a non-limiting example: Imagine a user copying all files with the tag “financial data”. The term file or data as used herein may be deemed to refer to any data stored on a storage device, including but not limited to a file, record, table, binary object, etc. as would be appropriate unless the context clearly dictates otherwise. The files may be stored in numerous scattered folders, but conventional software can copy all of them with a single command. The invention would be applicable to this type of access. Thus the term folder may be deemed to refer to any one or more of the above groupings as would be appropriate unless the context clearly dictates otherwise. One skilled in the art will understand from this disclosure how to apply the disclosed methods to these other devices without undue experimentation.

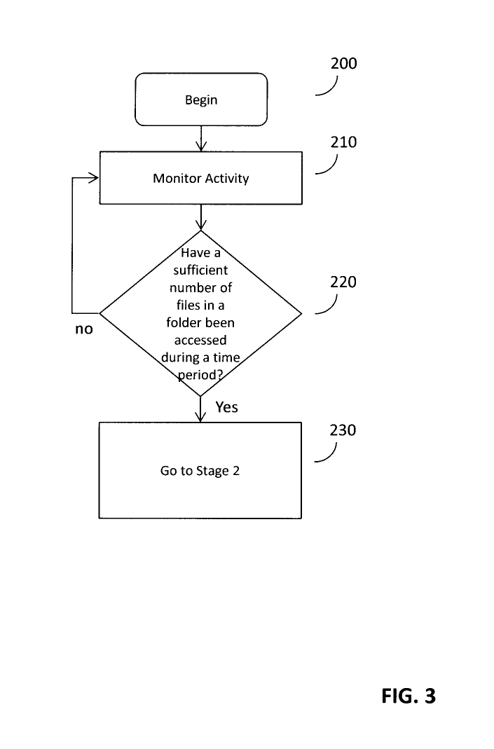

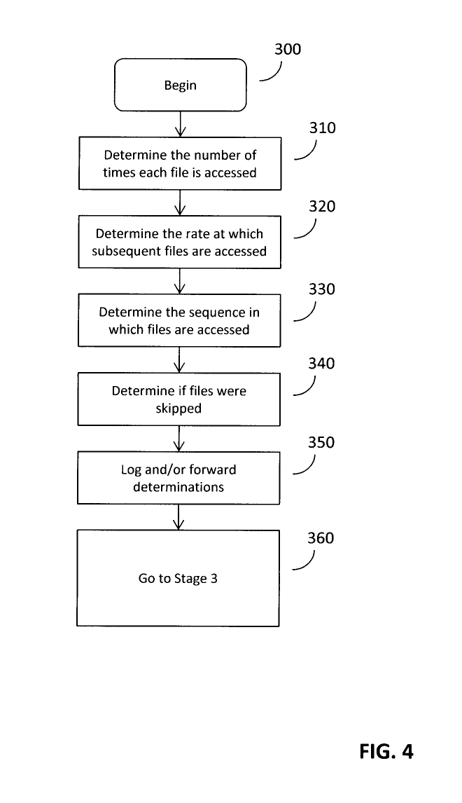

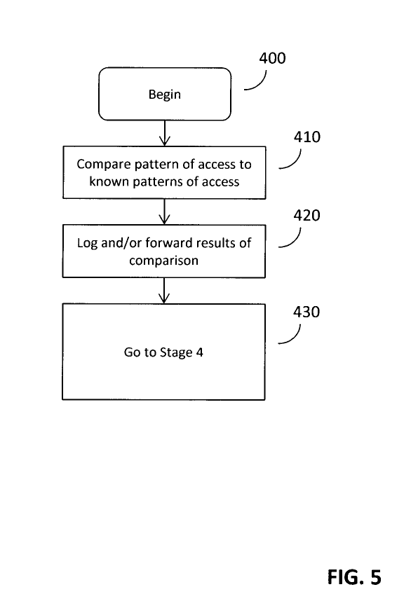

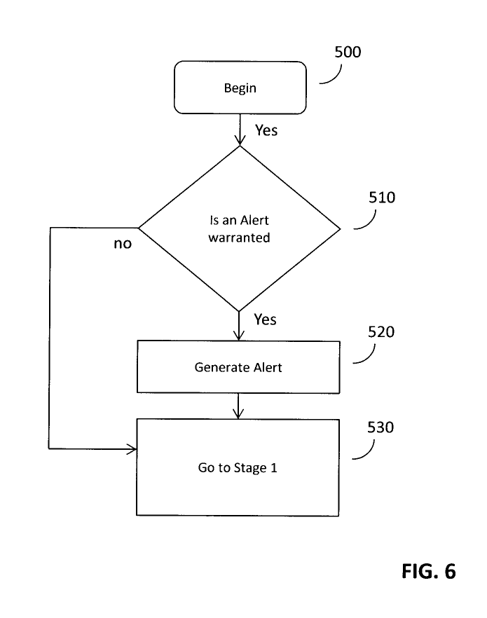

The invention may be best described in terms of stages, however, not all stages need to be performed in every configuration of the invention, the order of the stages may not be critical and the functions described in each stage are not required to be limited to a particular stage. One or more aspects of the invention provide(s) the following general features: stage 1 (FIG. 3)—monitor file activity 210 (optionally on a per user basis) on a network device over discrete time periods (such periods of time may be sequential but preferably overlap at least partially), determine if all, nearly all, or some minimum number or percentage of files within a folder were accessed during at least one of the time periods 220; if the requisite number of files were accessed during the time period go to stage 2 230; stage 2 (FIG. 4)—determine if the files were all accessed by a single action (e.g. by the same entity performing a single command such as copy folder X, copy all financial data, copy all .pdf files, etc. as opposed to randomly opening and closing files a, b, c, d, etc. which all belong to folder X or which may even be all of the files in Folder X)—determine the pattern of the file access (e.g. determine the number of times each file is accessed 310, the rate at which subsequent files are accessed 320, the sequence in which they are accessed 330, are any files skipped 340, etc.); stage 3 (FIG. 5)—analyze the pattern of access 410 (e.g. was the access performed by an entity that was authorized to perform the access, does the access pattern match a known pattern of copying, does the access pattern match a known pattern of benign access such as a virus scan, a search, etc. or does the access pattern not match a known pattern of access) and store the results and/or provide the results to another stage, program and/or device 420. Stage 4 (FIG. 6) may include generating an alert 520 that additional investigation may be warranted and/or that copying has taken place and/or an informative message stating what action was taken (e.g. John S. performed a virus scan of folder X, Jane D. performed a search through folder Y, John Q. P. copied folder Z using Windows Explorer Copy & Paste, etc.). Those skilled in the art will recognize that the order of the above operations may not be critical. For example, one or more embodiments of the invention may monitor access of a particular user and determine if that user accesses files in a folder during a time period and one or more embodiments of the invention may monitor all files accessed and only when the requisite number of files of a folder are accessed will the embodiment(s) determine if they were accessed by the same user, while still one or more embodiments may perform the functions without user information. Additionally the invention may be configured to only provide an alert if a minimum number of files have been copied. By way of a non-limiting example, the invention could be configured to ignore copying of an empty folder or a folder that only contains 1 or 2 files and still fall within a scope of the invention. The following description focuses on an embodiment that monitors access to files without first determining the entity accessing the files. Those skilled in the art will recognize that the description is equally applicable for understanding an embodiment in which it is first determined which entity is accessing the files.

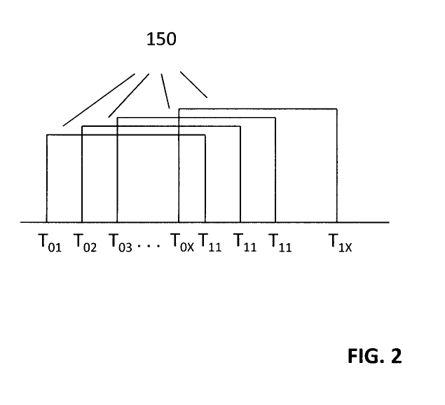

Turning to FIG. 1 a networked computer 10 is illustrated. Files are stored in a hierarchical manner (e.g. in folders, or some other hierarchical structure) on storage device 30 within networked computer 10. Those skilled in the art will recognize that storage device 30 could be an internal device an adjunct device or a device accessible via the network 70. A sensor/monitor 2 is connected to computer 10 either internally as an adjunct device or via the network 70. Sensor 2 may be realized in hardware, software or a combination thereof. Sensor 2 performs the operations of stage 1. Sensor 2 monitors file activity (e.g. time of access) on computer 10 over discrete time periods 150 (FIG. 2), determines if all, nearly all, or some minimum number or percentage of files within a folder were accessed during at least one of the time periods; and if the requisite number of files were accessed during the time period determines if they were all accessed by virtue of a single action. It may not always be possible to identify an entity that performed the single action in which case either the system could be configured to default to assuming that it was the same entity, default to assuming that it was not the same entity or default to make an assumption based upon one or more conditions (e.g. time of day, number of files accessed, number of users logged into the network, etc.).

As illustrated in FIG. 2, multiple time periods 150 are preferably employed. Dividing a stream of activity into time periods and users or entities is conventionally referred to as sessionization. Any standard sessionization technique may be employed with the invention. The various time periods 150 preferably overlap and have a fixed identical duration although those skilled in the art will recognize that these are design choices and the time periods 150 could have different durations and/or be sequential in time and still fall within a scope of the invention. Additionally, time periods 150 may be adaptive (e.g. no fixed length as long as not more than 5 minutes of inactivity; or length depends on the observed rate of access). In practice, the time periods 150 are set to 1 minute, however, this is a design choice and other time periods can be employed.

Information gathered by sensor 2 is provided to and/or accessed by analyzer engine 4 which performs the operations of stage 2. Analyzer engine 4 uses the information obtained by sensor 2 and calculates various properties (e.g. rate of accesses; the number of times each file was accessed; the sequence in which they were accessed; which files were accessed and which ones were not accessed). Properties can be simple or compound. A non-limiting example of compound properties would be: the average interval between access of type A and access of type B; or after performing access of type A, is access of type B performed next; or after performing access of type A, how many times is access of type B performed. Analyzer engine 4 also determines if the access falls entirely within a particular time period 150 (FIG. 2). As with the sensor 2, analyzer engine 4 could be internal to computer 10, adjunct thereto or connected via the network 70 and could take the form of hardware, software or a combination thereof. The results from analyzer engine 4 may be stored and/or provided to another program or device.

Analyzer engine 4 may operate in various different modes. For example, it may analyze the results from sensor 2 in discrete time intervals 150 and then rerun the results from sensor 2 over the same, a longer or shorter period of time in an attempt to learn additional information. Additionally, analyzer engine 4 may be configured to continuously analyze all folders in the system and then rerun the analysis on a specific folder or group of folders less frequently. Alternatively it may operate in reverse. It may be configured to continuously analyze activity in one or more folders then less frequently rerun the data for all folders. It could also be configured to periodically or sporadically analyze some or all activity and at different periods rerun the same or different activity.

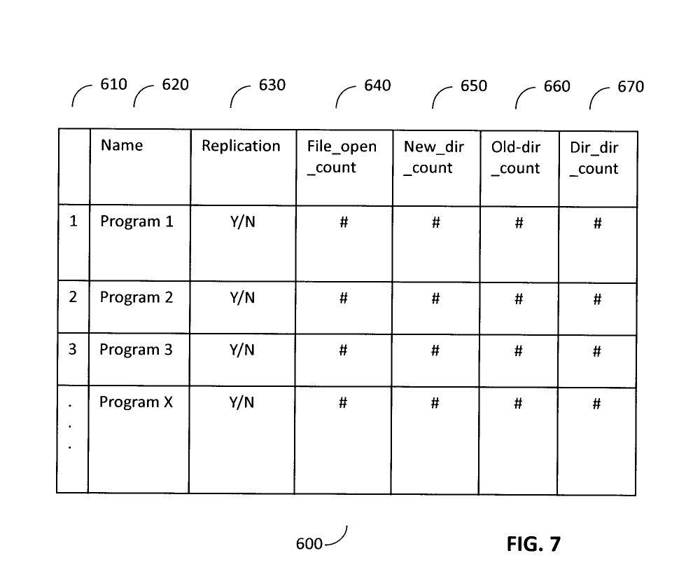

In one or more embodiments, the results from the analyzer engine 4 are provided to and/or accessed by a classifier 6 which performs the operations of stage 3. Classifier 6 compares the results from the analyzer engine 4 to a database 600 of known patterns of access such as the one illustrated in FIG. 7. Those skilled in the art will recognize that while it is preferable to store the patterns of access as data within a database, such data may be stored as any conventional formatted list or the patterns may be included within the code or the algorithms. The database 600 illustrated in FIG. 7 is one of many possible databases that may be employed. Examining the columns from left to right, the first column 620, after the row numbering 610, lists various programs with known access patterns. The next column 630 is a Boolean value indicating whether or not the program performs replication of data. The column 640 after the replication indicator (File_open_count) represents how many times the program opens a file. The next column 650 (New_directory_count) represents how many times the program opens a directory the first time it accesses that directory. The following column 660 (Old-directory_count) represents how many times the program opens a directory when it is not the first time it has accessed that directory. The final column 670 (Directory_directory_count) represents the number of times the program opens one directory then goes to another directory that has already been opened previously. These columns and the information contained therein are merely one example of possible methods for identifying patterns of access. Those skilled in the art will recognize that fewer or additional columns could be employed and the columns could represent entirely different information or some of the same information and some different information.

The list of patterns may include only benign patterns of activity (such as search and system activities), only potentially dangerous patterns of activity such as copying activities (e.g. Windows Explorer Copy & Paste of folder to fixed disk, Windows Explorer Copy & Paste of folder to USB thumb drive, XCOPY/S of folder, cp-r of folder, WinZip of folder, WinRAR of folder, 7-Zip of folder, Upload folder via FTP, Transmit folder via DropBox, etc.) or a combination thereof. Depending upon the configuration of the system the analyzer engine 4 may be configured to look for patterns matching only benign activities, only potentially hazardous activities, a combination of both and/or patterns that do not match any stored pattern. Regardless of the configuration, the analyzer engine may be further configured to store and/or forward and/or discard the above information.

In one or more embodiments, the results from the classifier are provided to and/or accessed by an alert generator 8 which performs the operations of stage 4. Alert generator 8 may be configured to provide an alert for receipt by an administrator or some other entity (machine or man). The alert may take many different forms and formats and still fall within a scope of the invention. For example, the alert could simply be informative providing information such as, but not limited to, the time, entity and action that took place (e.g. At 1 pm Jane Doe ran a virus check on folder X, etc.) The alert could be an indication that further analysis may be warranted (e.g. in the event that the pattern matches a copying pattern or does not match any pattern). The alert could also be conclusory providing information such as, but not limited to, the time, entity and action that took place (e.g. At 1 pm John Q Public performed a copy of the files in folder X, etc.). There are many different types of alerts that can be provided with the information obtained by the above apparatus and methods. The type of alert and the information and/or lack of information therein is a design choice.

The alert from alert generator 8 may take the form of an audio alert, a visual alert or a combination of the two. The alert preferably takes the form of a tone and a message that is displayed on an administrator's display, which includes the time of the copying and the folder that was copied (and in the event that the tool is identified, the identity of the tool employed). Those skilled in the art will recognize that the alert could take many different forms and still fall within a scope of the invention. For instance, the alert could be an email message, a text message sent to a mobile device, a message displayed without a tone, a multimedia alert, etc. The alert could also be provided to multiple devices (simultaneously, serially or in some other pattern). The type and form of the message are design choices. Additionally or alternatively, the alert could be stored locally and/or remotely, and/or sent to one or more remote log files (such as a logfile, Windows Event log, or syslog), log engines (e.g. Splunk), a Security Information and Event Management (“SIEM”) product, recorded into a database, sent to a correlation system, and/or analytics system, etc.

In operation, one or more of the below described methods may be employed to achieve the desired results. Those skilled in the art will recognize that the below is only an example for achieving the above identified results. Other methods may be employed without departing from a scope of the invention to achieve the same or similar results. For purposes of this description access means opening or reading a file or folder (“fildir”) and thus the terms shall be used interchangeably herein as fits the context. Modern filesystems implement folders as special types of files called “directories”—to enumerate a folder's contents, the system accesses and reads the directory file—thus, copying will invariably access a directory before accessing its files and subfolders. Thus, the terms directory and folder shall be used interchangeably herein.

Every period T, run stage 1 and if it yields a possible target run stage 2.

### Stage 1:

1. Load all access information that has occurred between timeT₀₁ and T₁₁ (FIG. 2) into RAM.
2. Divide these accesses into sessions, based on the performing entity, computer or IP addressed use, hiatus in time, etc. —any standard sessionization technique may be employed.
3. Iterate through each session and:
   a. Determine the set of all fildirs accessed in the session (“fildir_set”).
   b. Initialize a data structure called candidates. The structure should hold a set of candidate folders, and, for each candidate folder, contain the total number of descendants that the folder has on the filesystem (“descendants_count”). It also should store, for each candidate folder, a variable called “descendants_accessed_count,” which should be initialized to zero. This structure will be referred to as candidate_folders.
      Initially, there are no candidate folders in this structure—it starts as an empty set.
c. Iterate through every fildir in fildir_set. For each fildir in the set:
   i. Determine the set of all ancestors of the fildir. We will refer to this as set A, and add all members of set A to candidate_folders. (For example, if the fildir is
      /documents/bob/financial_planning/2013/spreadsheet.xlsx, then we would add to candidate_folders /documents/bob/financial_planning/2013, /documents/bob/financial_planning,/documents/bob,/documents, and /). If any of these folders are already in candidate_folders, then no operation is performed.
   ii. For each member of A, increment the descendants_accessed_count variable in candidate_folders associated with that. (For example, in the above case, increment candidate_folders[/documents/bob/financial_planning/2013].desce ndants accessed_count, candidate_folders[/documents/bob/financial_planning].descendants_accessed_count, candidate_folders[/documents/bob].descendants_accessed_count, etc.)
d. An objective is to find which, if any, candidate_folders are possible targets for an action. To do this, iterate through candidate_folders, and select all folders which have two properties:
   i. descendants_accessed_count/descendants_count>threshold
   ii. descendants_accessed_count>threshold
      Any folder which meets both those properties is a possible target of an action. If no folder meets both those properties, the session probably did not have an action.
e. If multiple folders meet those conditions, they may all be processed. Alternatively, only the one with the highest descendants_count, or one(s) that meet some other criteria may be processed.
f. To increase accuracy, some additional filtering may be performed, and then steps b, c, d and e are repeated. This additional filtering improves accuracy. It could always be done, but, for performance reasons, it is preferred to only do it if the unfiltered version shows some possible targets.
The filtering works as follows: Iterate through fildir_set, and remove from it any file (or fildir) that is accessed before its parent has been accessed. Then proceed with steps b et seq.
g. A fildir_set remains and zero or more possible targets. Optionally any fildir which is not a descendant of a target may be further filtered out from fildir_set. This is useful for Stage 2. This filtered set will be referred to as filtered_segment.
Stage 2 (FIG. 4)
   For each filtered_segment, calculate the following:
1. How many times each file is opened.
2. How many times each directory is opened in a row, the first time it is encountered.
3. How many times each directory is opened in a row, when (i) it has been opened before and (ii) a different directory was opened immediately prior to it.
4. How many times each directory is opened in a row, when (i) it has been opened before and (ii) a file was opened immediately prior to it.
In some cases, the answers to 1-4 will vary. There are multiple ways to handle this, including checking both, taking the average, etc. A preferred method includes taking the most common one, but any standard statistical technique will work.

This will produce 4 numbers. These four numbers can be compared to the database to determine if any known action has values equal to, or close enough to, those 4 numbers to conclude that a match exists. This will result in zero, one, or more than one possible action.

There are other ways to compute these, and other similar properties to compute. For example it could be replaced with timing issues: what is the interval between accesses, how does the interval correlate to file size, to file type. Likewise: Are any files or file types omitted.

Using finite state machines, many other properties can be computed. Model each access as a state in the finite state machine, and determine which type of finite state machines could generate this access pattern. Additionally, other statistical properties can be computed, such as average, standard deviation, median, probability distribution. An alternate approach, instead of measuring properties and then checking for a match in the database, is to store, generate or predict the pattern that a particular program would use, and then determine how closely it matches the observed pattern. This can be done using standard sequence comparison techniques (as often used in DNA research). A non-limiting example of an algorithm that could be employed is the Longest Common Subsequence (LCS) algorithm.

In cases of high volume, the system may perform some pre-filtering to eliminate certain access that may skew the pattern. This is typically reserved for use with high volume; otherwise, the sessionalization and filtered_segment are sufficient.

Likewise, in cases of noisy data, these calculations and comparisons should be performed in a forgiving or fuzzy manner, so that a few noisy, missing, or spurious accesses don't cause the comparison to be rejected.

At this point the possible action(s) may be reported or it may not be worth reporting—in that case, the system does not need to report the specific action, only that a reportable action may have taken place. Likewise, if the action is unknown, it can be reported that an unknown action took place, or it can be ignored, or report that a reportable action took place without elaborating.

While one or more embodiments may perform all of the above steps and all of the above operations, one or more embodiments will only perform some or one of them. Similarly, one or more embodiments may perform an operation multiple times, each time using different criteria.

One or more embodiments will, for reasons of speed and efficiency, perform some of the steps of the operations in different order than the examples listed above, or perform some of them in parallel with each other, or perform some of them simultaneously with each other. Likewise, for reasons of speed and efficiency, some embodiments will avoid removing records from an array or copying them to another array, and instead modify the records in place in the array or use auxiliary storage in RAM.

### CONCLUSIONS, RAMIFICATIONS, AND SCOPE

The invention can be used to examine an information system or filesystem and determine the nature of the access performed on it. It can do so without requiring the information system to have been specially modified beforehand, and without requiring access to any evidence or artifacts other than the information system or filesystem itself. It can be used in this situation to determine if data was copied. It can be used to determine the nature of activity or access done on the data of the information system. It can be used as part of a forensic examination, or in other scenarios.

Thus it is seen that apparatus and methods are provided for detecting data access activity in real-time. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, but in no way exhaustive, rather than examining all folders in the system, the invention could be configured to only watch/analyze one or more specified folders. While the invention has been described in terms of file access it does not need to be so limited. It can operate on any individual event(s) which can be grouped into macro events. In other words, the invention can work to provide information about a macro event, based only on observations about micro events. For example, if macro event A would cause micro events A1, A2, A3, etc., and the system observes A1, A2, A3, it is likely that macro event A took place. This is especially true if it is unlikely that A1 and A2 and A3 would all take place randomly (i.e. a large number of micro events are caused by A, and as a result of action by a single entity a large number of them all took place within a short interval of time). In terms of data access detection, a macro event would be copying a folder, a micro event would be opening a file and multiple micro events that are caused by the macro event would be the opening of multiple files in the folder within a short interval of time by virtue of a single action. Further, if there may be multiple macro events that could cause the same set of micro events (e.g. macro events AA, AB, AC, AD). Although each of these separately cause micro events A1, A2, A3, etc., they may cause them with different patterns (e.g. different sequence, timing, frequency, etc.). To distinguish between AA, AB, AC, AD, the pattern of the micro events is computed, and a determination is made as to which macro event, if any, best matches the pattern. In terms of data access detection, AA could be copying with Explorer, AB could be running a virus scan, AC could be a search, etc. Additionally, the data could be arranged in a tree structure or in any other grouping or delineation. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described apparatus is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for detection of data access in a storage device, the method comprising:
a processor monitoring access to a set of data stored on said storage device; and
said processor detecting access, within a time period, to an amount of said data that exceeds a threshold amount of said set of data, wherein at least a portion of said set of data was stored on said storage device prior to said time period.

2. The method according to claim 1, further comprising:
said processor determining a pattern of said access.

3. The method according to claim 2 wherein said data is stored in a directory and said determining said pattern of access includes determining how many consecutive times said directory is opened a first time that said directory is accessed.

4. The method according to claim 2 wherein said data is stored in a directory and said determining said pattern of access includes determining how many consecutive times a directory is opened when it is not a first time that said directory is accessed.

5. The method according to claim 2 wherein said set of data is stored within a folder.

6. The method according to claim 2 further comprising:
said processor storing said pattern of access in memory.

7. The method according to claim 2 further comprising:
said processor storing said pattern of access in storage.

8. The method according to claim 2 further comprising:
said processor forwarding said pattern of access for subsequent processing.

9. The method according to claim 2 further comprising:
said processor determining, based on said pattern of said access, that said access was performed by a single action and that said access warrants further investigation; and
said processor generating an alert in response to said determining that said access warrants further investigation, said alert indicating that further investigation may be warranted.

10. The method according to claim 9 wherein said determining that said access warrants further investigation includes comparing said pattern of access to at least one known access pattern.

11. The method according to claim 2 further comprising:
said processor comparing said pattern of access to a set of known access patterns;
said processor determining that said pattern of access matches at least one known access pattern in the set of known access patterns and that said access was thus performed by a single action; and
said processor generating an alert indicating that said pattern of access matches a known access pattern.

12. The method according to claim 2 further comprising:
said processor comparing said pattern of access to a set of known access patterns;
said processor determining that said pattern of access does not match an access pattern in the set of known access patterns; and
said processor generating an alert as a result of said determination.

13. The method according to claim 11 wherein said comparing includes comparing said pattern of access to a pattern of access known to be benign and determining that said access pattern and said pattern of benign access do not match.

14. The method according to claim 1 wherein said threshold of data is a majority of said data.

15. The method according to claim 1 wherein said threshold of data is all of said data.

16. The method according to claim 1 wherein said threshold of data is a percentage of said data.

17. The method according to claim 1 wherein said processor monitors said access to said set of data in real-time.

18. The method according to claim 17 wherein set of data includes a plurality of sets of data and said processor monitors access to said plurality of sets of data in real-time.

19. The method according to claim 18 wherein said plurality of sets of data are respectively stored within a plurality of folders.

20. A method for detecting data access on a storage device, the method comprising:
creating a set of access patterns related to a plurality of software programs;
analyzing, using a processor, access to a set of data which has been previously stored on said storage device, and detecting a pattern of said access to said set of data;
said processor comparing said pattern of access to said set of access patterns; and
said processor storing, at least temporarily, a result of said comparison between said pattern of access and said access patterns.

21. The method according to claim 20 further comprising:
flagging at least one of said plurality of software programs; and
said comparing said pattern of access to said access patterns in said database resulting in a match between said pattern of access and said access pattern of said flagged program.

22. The method according to claim 20 wherein at least one of said plurality of software programs performs replication, said method further comprising:
said processor generating an alert message indicating that said pattern of access matches said access pattern of a software program that performs replication.

23. The method according to claim 20 wherein said processor is configured to detect when an amount of data access crosses a minimal threshold of access and only analyze data access that crosses said threshold.

24. The method according to claim 20 wherein said pattern of access indicates that said data access exhibited at least one of the characteristics selected from the group of characteristics consisting of it was nonselective, all subfolders and files were accessed, the access was temporally continuous, the access was recursive and a directory was accessed before each of the files in said directory.

25. The method according to claim 20 wherein said analyzing access to a set of data which has been previously stored on said storage device occurs in real-time.

26. Apparatus for detecting data access in a filesystem that stores data in groups, said apparatus comprising:
a sensor configured to monitor, in real-time, access to data stored in a group;
said sensor further configured to store a plurality of times associated with said access;
an analyzer engine configured to determine, from said stored plurality of times, that said accessed data includes an amount of data, from said group, that exceeds a threshold amount of data.

27. The apparatus according to claim 26 wherein said analyzer engine is further configured to determine that said plurality of times falls within a predetermined time period and that a pattern of said access does not match a pattern of benign access.

28. The apparatus according to claim 27 further comprising an alert generator in electrical communication with said analyzer engine, said alert generator configured to generate an alert when said analyzer engine determines that a pattern of said access does not match a pattern of benign access.

29. A method for detection of data access in a storage device, wherein a set of data has been previously stored on said storage device, the method comprising:
a processor monitoring access to said set of data, wherein said set of data is stored as a group of data; and
said processor detecting a plurality of times of access to an amount of said data that exceeds a threshold amount of said set of data; wherein each of said plurality of times falls within a time period.

30. The method according to claim 29 further comprising said processor determining a pattern of said access based on said plurality of times.

31. The method according to claim 29 wherein said determining a pattern of said access includes determining a number of times a member of said set of data is accessed.

32. The method according to claim 31 wherein said determining a pattern of said access includes determining a number of times a plurality of members of said set of data are accessed.

33. The method according to claim 29 wherein said determining a pattern of said access includes determining a sequence in which a member of said set of data is accessed.

34. The method according to claim 33 wherein said determining a pattern of said access includes determining a sequence in which a plurality of members of said set of data are accessed.

35. The method according to claim 29 wherein said determining a pattern of said access includes determining a rate at which a member of said set of data is accessed.

36. The method according to claim 35 wherein said determining a pattern of said access includes determining a rate at which a plurality of members of said set of data are accessed.

37. The method according to claim 30 further comprising:
said processor comparing said pattern of said access to a plurality of known patterns of access.

38. The method according to claim 37 further comprising:
said processor determining that said access to said amount of data that exceeds said threshold was performed by a single action; and
said processor generating an alert as a result of said determining that said access to said amount of data that exceeds said threshold was performed by a single action.

39. The method according to claim 38 wherein said monitoring said access to said set of data is performed in real-time.

40. A method for detection of a macro event, the method comprising:
a processor monitoring a plurality of micro events, wherein a plurality of said micro events may be grouped into at least one macro event; and
said processor detecting an occurrence of an amount of said micro events that exceeds a threshold amount of occurrences of said micro events within a time period.

41. The method according to claim 40 wherein said micro event includes accessing on a storage device a file that has been previously stored on a storage device.

42. The method according to claim 41 wherein said macro event includes copying a folder which has been previously stored on said storage device.

43. The method according to claim 40 wherein said monitoring occurs in real-time.

44. The method according to claim 40 further comprising said processor determining a pattern of said micro events.

45. The method according to claim 44 wherein said determining a pattern of said micro events includes determining a number of times a micro event occurs within said time period.

46. The method according to claim 45 wherein said determining a pattern of said micro events includes determining a number of times at least two of said plurality of said micro events occur with said time period.

47. The method according to claim 40 wherein said determining a pattern of said micro events includes determining a sequence in which a micro event occurs within said time period.

48. The method according to claim 47 wherein said determining a pattern of said micro events includes determining a sequence in which at least two of said plurality of micro events occur within said time period.

49. The method according to claim 40 wherein said determining a pattern of said micro events includes determining a rate at which a micro event occurs within said time period.

50. The method according to claim 49 wherein said determining a pattern of said micro events includes determining a rate at which at least two of said plurality of micro events occur within said time period.

51. The method according to claim 44 further comprising said processor comparing said pattern of said micro events to at least one known pattern of a macro event.

52. The method according to claim 51 further comprising said processor determining that said comparison results in a match and determining as a result of said comparison resulting in a match that a macro event has occurred.

53. The method according to claim 51 wherein said comparing said pattern of said micro events to said at least one known pattern of a macro event does not result in a match.
